(19) United States
(12) Patent Application Publication
(10) Pub. No.: US 2006/0251269 A1
(43) Pub. Date: Nov. 9, 2006

(54) Anatomy data-collection with low-frequency noise-cancellation capabililty

(75) Inventor: Peter T. Bauer, West Linn, OR (US)

Correspondence Address: ROBERT D. VARITZ, P.C., 4915 SE 33RD PLACE, PORTLAND, OR, 97202, US

(73) Assignee: Inovise Medical, Inc.

(21) Appl. No.: 11/416,984

(22) Filed: May 2, 2006

Related U.S. Application Data
(60) Provisional application No. 60/677,885, filed on May 4, 2005.

(51) Int. Cl. H04B 15/00

(52) U.S. Cl. 381/94.1

(57) ABSTRACT

A system and a method for clearly obtaining heart sounds in the presence of noise, including, from a systemic point of view (a) a pair of close-proximity sound transducers applied to a pair of sites on the human body for gathering heart and external-source sounds, and for producing from such gathered sounds related, electrical signals, (b) structure coupled to these two transducers for receiving, and producing electronic subtraction, one-from-another, of, such two produced signals, and (c) structure operatively connected to the above first-mentioned structure, for producing a discernable, interpretable output based upon such electronic subtraction. Methodologically, the invention proposes (a) declaring low-frequency sounds which arrive at such transducers from the heart to be near-field sounds, (b) declaring all other low-frequency sounds which arrive at such transducers to be near-field sounds, and (c) employing the arriving far-field sounds in a self-cancellation mode to clarify information content in the arriving near-field sounds.

### CROSS REFERENCE TO RELATED APPLICATION

This application claims priority to prior-filed, currently co-pending U.S. Provisional Patent Application Ser. No. 60/677,885, filed May 4, 2005, for “Noise Cancellation Method and Apparatus for Heart Sounds”. The entire disclosure content of that Provisional Application is hereby incorporated herein by reference.

### BACKGROUND AND SUMMARY OF THE INVENTION

This invention pertains to anatomical acoustic-signal data collection with noise-suppression capability, and in particular, to such data collection with respect to which noise suppression which takes place, when required, with respect to the acquisition of anatomical data, and specifically data such as heart-sound data, is performed to enable accurate detection of important diagnostic heart sounds, such as the S1, S2, S3 and S4 heart sounds. While aspects of the invention—two preferred embodiments of which are disclosed herein—certainly have applicability in various fields of endeavor, these preferred embodiments, and the related manners of practicing the invention, have been found, as just suggested above, to offer particular utility in the examination of the functionality of the human heart through collecting and observing the conditions of heart sounds, such as the four heart sounds identified above.

In one embodiment of the invention, noise suppression is the “default norm” of behavior of the invention. In the other embodiment, noise suppression becomes an implemented and significant option under circumstances where collected anatomical signals, “tested” for excess noise content against what are referred to herein as “Gold Standard, non-noise affected, representative expected signals, are determined to include excess, “masking” noise.

Accordingly, and now describing and illustrating this invention, in the heart-sound-collection environment, heart sounds carry important diagnostic information about the mechanical and hemodynamic characteristics of the human heart. The main frequency content of such sounds, and in particular that of the S3 and S4 heart sounds, is well below 100-Hz, and their intensity is small. Both of these characteristics make it quite difficult for physicians to discern those heart sounds effectively and confidently.

Electronic processing, and/or computerized analysis of electronically collected heart sounds, help through a blend of appropriate filtering, of amplification of heart-sound signals, and of appropriate display and labeling of related traces or curves (typically time-based). However, applying filtering to heart-sound data only helps if the frequency content of ever-present noise is significantly different in frequency relative to that of the heart sounds of interest, per se. While the influence of ambient noise on sound-sensor systems can be reduced through sturdy and appropriate signal-collection design, those systems in the prior art have not been found to be immune to noise that is coupled to an acoustic sensor through the skin surface of a patient, i.e., through vibrations moving the whole body of a patient or simply moving just the skin in the area where a sound sensor, or transducer, is applied to the anatomy. This type of skin-conveyed (or skin-transported) noise can have frequency content which is similar to that of desired heart sounds, and is therefore often not distinguishable from heart sounds. Typical examples of environments where such noise presents problems includes the environments of emergency vehicles when an engine is running, such as in airplanes and helicopters, and even facility ventilation systems which are located in the vicinity of a patient whose heart sounds are to be collected for observation.

The present invention, in the herein-disclosed embodiment thereof wherein noise suppression is always, by default, invoked, features a system and a methodology which specially address these concerns. This system and methodology allow for and promote detection of heart sounds in noisy environments through utilizing a pair of sound sensors (also referred to herein as acoustic-to-electrical transducers) applied to a patient's chest, from which sensors collected sounds are subjected to a special noise-suppression approach which is uniquely proposed by the structure and methodology of the present invention.

Noise suppression, or cancellation, as proposed by the present invention, takes advantage of the physical nature of low-frequency heart sounds and potentially interfering noise sounds. Sounds with frequencies below about 100-Hz travel through the human body mainly in the form of shear waves having low propagation speeds which lie typically in the range of about 1- to about 10-meter(s)-per-second. The exact propagation speed will depend on the density and the shear modulus of the particular material(s) through which the waves

I have discovered that if two or more sound sensors are placed in relative close proximity to each other, i.e., within about 2- to about 3-centimeters or so from one another, one can easily detect that the frequency content and the phase relationships of acoustic signals collected by those sensors are different. These differences are normal and expected, since sound waves transmitted from the heart to such two sensors will travel unavoidably through slightly different mechanical, anatomical paths in the human body. Such different paths have different lengths and different material make-ups, and this means that the travel time for sounds in these two paths will differ for a given sound and for each of the employed (skin-attaches) acoustic sensors.

However, in contrast to near-field heart-generated sounds, external sound vibrations, that is, sound vibrations existing in the environment which is on the outside of the anatomy, will couple into such plural sound sensors directly through the surface of the human body, i.e. through the skin, via surface waves. Since these external sound vibrations effectively have a far-field source, and since the propagation speed on the anatomical surface is essentially the same for all such far-field acoustic signals, these signals, referred to herein as noise, will appear to be in phase and characterized with the same frequency content in each one of the anatomical-contact sensors employed.

Accordingly, these fundamental differences between the natures and propagation properties of heart sounds as compared to external vibration noise can be used to construct, as proposed herein, a simple and unique noise-cancellation system contemplated by the present invention.

In accordance the particular embodiment of the invention wherein noise suppression always takes place, and in relation to the other mentioned embodiment of the invention when it is “activated” to suppress noise, the manner of practicing noise suppression is illustrated herein in the context of the utilization of two acoustic, or sound, transducers attached to the anatomical surface, preferably at the conventional V3 and V4 ECG signal sites on the anatomy. Signals collected by these two transducers will, in each case, include a combination of heart-sound-signals blended (combined) with skin-surface-conveyed, external, acoustic noise signals.

Recognizing the differences which will exist in each combined signal (as described above) with respect to (a) signals coming from the heart, and (b) signals coming from external sources, a very simple subtraction of one of these two acquired signals from the other, in the particular case where two sound transducers are employed, will produce, effectively, a full cancellation of in-phase surface-conveyed noise signals, and a very clear revelation at the same time of the desired-to-be-detected heart signals.

These and other specific and more generalized utility features of the present invention will now become more fully apparent as the description of the two embodiments which follows is read in conjunction with the accompanying drawings.

### DESCRIPTION OF THE DRAWINGS

FIG. 1 is a high-level, simplified, block/schematic diagram illustrating generally two different sound sources (A and B), and three different acoustical conveyance media associated with those sources for conveying sounds from the sources to a pair of acoustical-to-electrical transducers in accordance with the structure and methodology of the present invention. These two transducers are attached, during practice of the invention, at the conventional V3 and V4 ECG electrical signal sites on the anatomy. Source A, a far-field source, exists and functions on the outside of the anatomy. Common Medium A, which couples sounds from source A to each of the two transducers, is the skin. Source B, a near-field source, is the heart, and the B1 and B2 media which convey sounds from the heart to each of the two transducers, respectively, are portions of the inside anatomy extending from the heart to the locations of these respective transducers.

FIG. 2 is also a high-level, simplified, block/schematic diagram illustrating, in one preferred embodiment of the invention, sound-transducer collection of combined acoustical signals which arrive substantially simultaneously at the two sound transducers shown in FIG. 1, which transducers are attached, as mentioned above, to the anatomy. This figure also illustrates signal processing which is performed downstream from the transducers to suppress unwanted noise which is that arriving from an anatomy-external sound source, such as sound source A in FIG. 1.

FIG. 3 is a photographic image illustrating actual placement of acoustic, or acoustical, (sound) transducers, or sensors, at the conventional V3 and V4 ECG electrical signal sites on a person's anatomy.

FIG. 4 is a time-based graph comparing acoustical heart sounds which, as they arrive at the two transducers pictured in FIG. 3 exhibit phase differentiation on account of the fact that they follow different acoustical paths between the heart and each of the two transducers. The waveforms, or traces, shown in FIG. 4 contain no noise components, and are referred to herein as being representative “Gold Standard” waveforms.

FIG. 5 is a time-based representation showing, in an upper curve 5A, an ECG waveform, and in the next-below curve 5B, acoustical energy picked up by an acoustic transducer located at the V3 anatomical site. The next-below curve 5C is like curve 5B above it, except that it pictures the acoustical information arriving at an acoustic transducer which is placed at the V4 anatomical site, and the lowest curve 5D illustrates output signal information obtained after appropriate subtraction, one from another, of the waveforms appearing in the two curves above it. The specific subtraction result which is pictured in curve 5D has resulted from the subtraction of curve 5C from curve 5B. This bottom curve 5D in FIG. 5 illustrates the capability of the present invention to isolate and make clearly detectable the desired-to-be-discerned heart sounds, and specifically shows clear detection of the S1 and S2 heart sounds under circumstances where noise suppression activity has been implemented.

FIG. 6 is a high-level, simplified, block/schematic diagram illustrating a preferred modification of the invention which deals with a condition wherein two anatomy-attached sensors which have been applied to the anatomy to collect acoustic signals are associated with signal-processing structure wherein positive noise suppression, implemented as illustrated in FIG. 2, is an option.

### DETAILED DESCRIPTION OF THE INVENTION

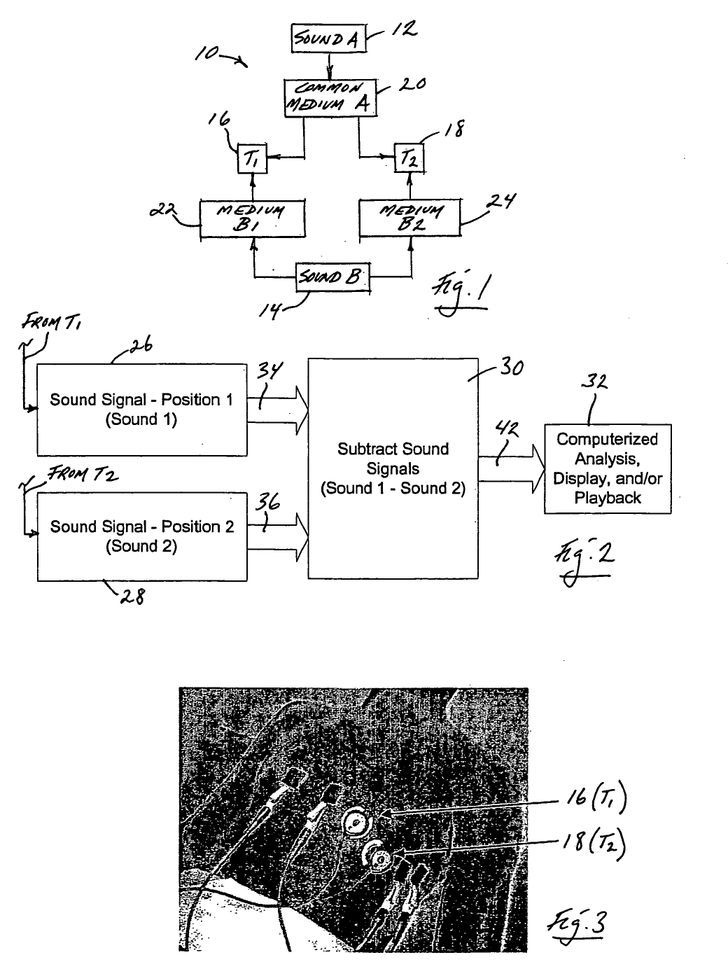

Turning now to the drawings, and referring first of all to FIG. 1, indicated generally at 10 is the overall acoustical environment, or system, wherein the methodology and structure of the present invention operate. Blocks 12 and 14, labeled SOUND A and SOUND B, respectively, represent two different sources of sound, also referred to herein as two different-character acoustical signal sources, which are to be dealt with in accordance with practice of the present invention. Block 12 (SOUND A) represents relatively low-frequency (typically below about 100-Hz) sounds which develop on the outside of the anatomy, such as those anatomy-external sounds mentioned earlier herein. Block 14 (SOUND B) represents sounds emanating from the heart as a source of acoustic signals which are desired to be detected accurately. In particular, and in the illustration of the invention embodiment now being described, of special interest among these heart sounds are the desired, recognized S1, S2, S3 and S4 heart sounds.

Outside environmental sounds from block 12 are effectively ultimately coupled to a pair of what are referred to herein as close-proximity sound sensors, also called acoustical-to-electrical transducers, T1, T2 represented by blocks 16, 18, respectively. These sensors, which are referred to collectively as a plural-signal receiver, are placed in contact with a person's anatomy during use of this invention, with transducer T1, for example, being placed on the anatomy at the well-known V3 ECG electrical signal site, and transducer T2 being placed at the well-known V4 ECG electrical signal site. The specific positions just mentioned associated with transducers T1, T2, could, of course, be reversed, and it should also be recognized that more than two transducers could be employed, in accordance with practice of the invention, if a user so desires. Notwithstanding that latter statement, a preferred practice of the invention, as illustrated and described herein, is styled to employ simply the two transducers designated 16, 18.

Acoustical signals generated by source 12 are coupled to transducers 16, 18 through what is referred to herein as a common, undifferentiated conveyance medium, such being represented by block 20, labeled COMMON MEDIUM A. Medium A herein is very specifically the skin of a person with respect to whom the methodology of the invention is being practiced. As was mentioned earlier herein, this common, skin medium effectively delivers sounds from source 12 in phase, and substantially simultaneously, through low-propagation-velocity shear waves. As a reminder, the practice of the present invention is primarily concerned with unraveling noise confusion with respect to acoustic signals lying in a range generally below about 100-Hz. As was also mentioned earlier herein, propagation speeds for such signals in the form of shear waves carried by the skin might typically lie in the range from about 1- to about 10-meter(s)-per-second. Signals arriving at transducers 16, 18 through common medium A(20) are essentially in phase with one another at the location of transducers 16, 18.

By contrast, sounds emanating from the heart (source 14), which include the S1, S2, S3 and S4 sounds that are desired to be detected accurately, propagate toward transducers 16, 18 via two different anatomical paths made up of specific anatomical components, so to speak, which lie in the respective paths between the heart and the skin surface locations where transducers 16, 18 are placed. These two different paths are referred to herein as being two different transducer-specific media, and they are represented by blocks 22, 24 in FIG. 1, which are labeled, respectively, MEDIUM B1 and MEDIUM B2 herein. MEDIUM B1 lies in and defines the acoustical path between the heart and the transducer 16. MEDIUM B2 performs the same function between the heart and transducer 18. Media B1 and B2 are also referred to herein as sound-signal conveyance paths.

What one will note from the environment pictured in FIG. 1, is that acoustical signals arriving at transducers 16, 18 during a common time frame, or along a common time base, are received substantially simultaneously as combined signals which include components contributed by outside, or external, source 12, and by inside, or internal, source 14. The job of the present invention is to enable clear detection of just those sounds coming from heart source 14, and thus bears the responsibility, where necessary, for suppressing interference with sounds coming from source 14 by sounds coming from source 12.

Directing attention now to FIGS. 2, 3 and 4, the block/schematic diagram presented in FIG. 2, which includes, along with previously mentioned blocks 16, 18, blocks labeled 26, 28, 30, 32 clearly illustrates, at a level which will be plainly understood by those generally skilled in the relevant art, the structure and system of the currently-being-described embodiment of the present invention. Block 26 represents the combined sound, or acoustic (acoustical-to-electrical), signal which is collected by sensor, or transducer, 16 (T1). Block 28 represents the combined sound, or acoustic (acoustical-to-electrical), signal which is collected by sensor, or transducer, 18 (T2).

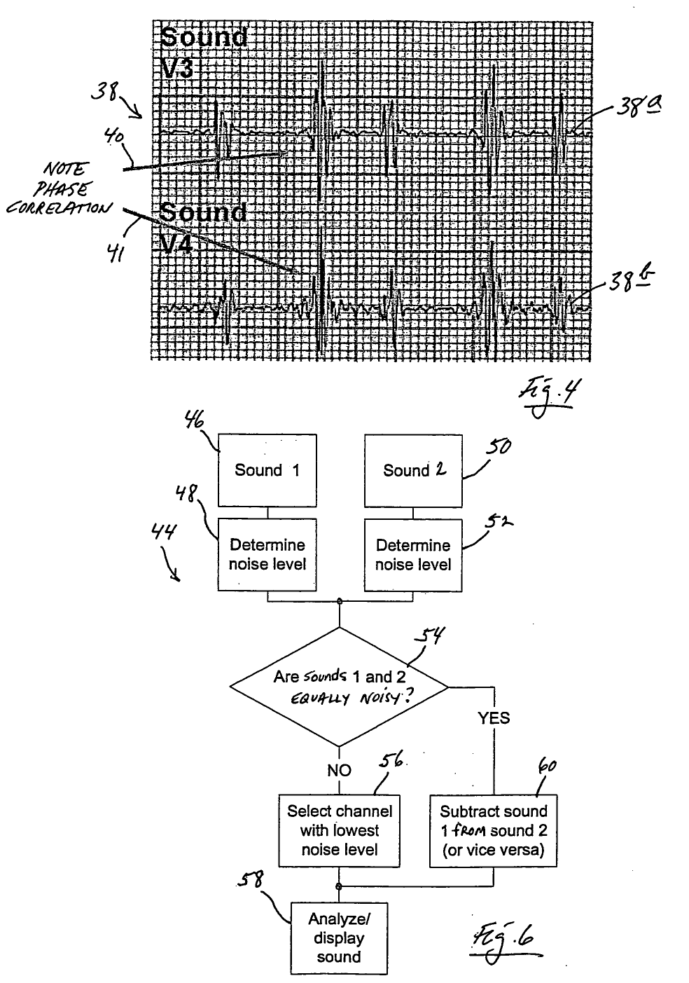

Digressing for just a moment to FIG. 3 in the drawings which is a photographic view of an actual implementation of the invention, sensors 16, 18 are shown on the chest of a person in this figure, with sensor 16 occupying the standard V3 ECG electrical signal site, and sensor 1 occupying the traditional V4 ECG electrical signal site.

The combined acoustical-to-electrical signals arriving from sensors 16, 18, which combined signals are represented, respectively, by blocks 26, 28, are coupled through appropriate signal-data connections 34, 36, respectively, to block 30 (seen in FIG. 2) wherein appropriate signal processing, performed in accordance with the practice of the present invention relative to the embodiment thereof which is now being described, is implemented to suppress acoustical noise signals received by the two sensors from outside the anatomy, as from source 12 shown in FIG. 1. Block 30 is referred to herein as subtraction structure.

Turning for a moment to FIG. 4, this figure provides a time-based graph 38 showing upper and lower traces 38a, 38b, respectively, which represent expected, pure, “Gold Standard” acoustical signals derived from the V3 and V4 anatomical sites, respectively. Trace 38a represents sound from the conventional V3 ECG electrical signal site, and trace 38b represents the same information received at the conventional V4 ECG electrical signal site. What one will especially note in FIG. 4 is that the same time-based acoustical signals arriving from the heart, as illustrated by arrows 40, 41, at the V3 and V4 sites, respectively, are specifically different. This difference results directly from the fact that the acoustical conveyance paths, MEDIA B1 and MEDIA B2 in FIG. 1, are different, and it is this difference which accounts for the visible, different trace (38a, 38b ) excursion values, as well as the evident intertrace phase relationships. As will become apparent, it is, among other things, the phase difference which exists between traces 38a and 38b that unmistakably differentiates the far-field and near-field combined signals arriving at transducers 16, 18 from sources 12, 14, respectively. Such phase-difference differentiation lies as a central useful feature in the practice of the present invention.

Returning attention especially to FIG. 2, within block 30, a simple signal-trace subtraction takes place, performed in any appropriate conventional manner. This subtraction results, because of the phase-difference condition just mentioned above, effectively with complete removal of the substantially in-phase acoustical noise signals arriving at transducers 16, 18 from source 12.

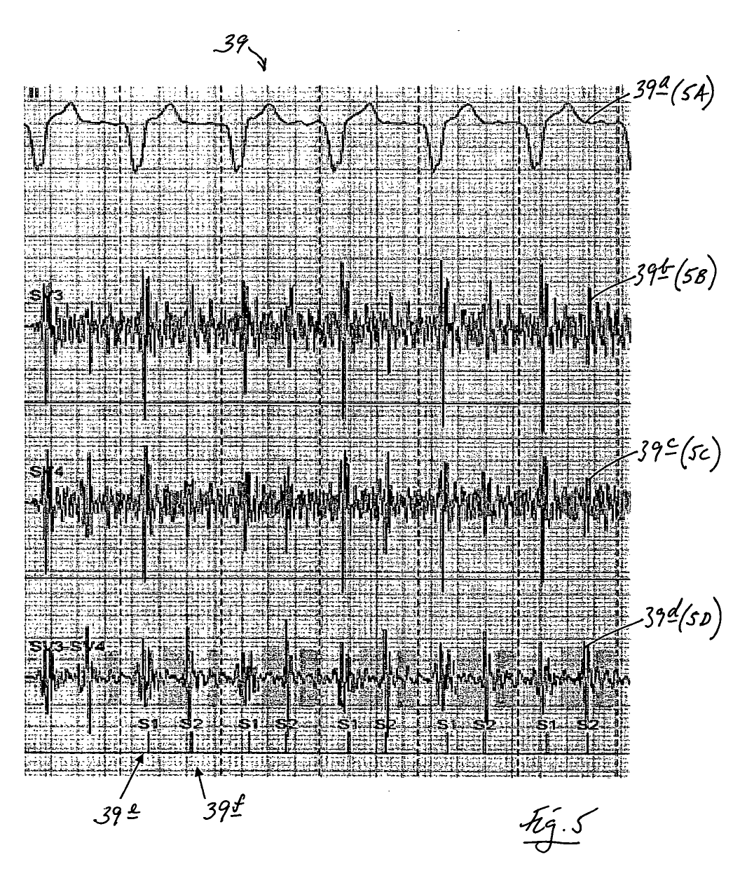

FIG. 5 in the drawings presents a plural-trace graph 39 which illustrates the result of this subtraction. Very specifically, pictured in FIG. 5 are four traces 39a (5A), 39b (5B), 39c (5C), and 39d (5D). Trace 39a is a conventional ECG electrical-signal trace. Trace 39b is a trace illustrating the combined noise and heart acoustical signals picked up at site V3 by transducer 16. Trace 39c illustrates the same combined kind of noise and heart acoustical signals picked up at site V4 by transducer 18. Trace 39d represents an illustration of the clear presentation, and separation from noise, of the heart sounds S1 and S2 (see, respectively, reference numerals 39e, 39f) made available after signal processing (subtraction of trace 39c from trace 39b) has been performed within block 30 (shown in FIG. 2).

Following performance of subtraction within block 30, and further in accordance with what is shown in FIG. 2, the subtraction result is supplied through a conventional data connection 42 to previously mentioned block 32 which, as labeled in FIG. 2, enables several different utilizations of the subtraction-result information. Specifically, within block 32, which is also referred to herein as interpretable output producing structure, data received over connection 42: (a) may be studied by an appropriate algorithm which is designed to analyze heart sounds; (b) may be displayed as a waveform on a screen for viewing; and/or (c) it may be played back as an audio signal. All three of these outcomes may be employed together, or any one or two of them, as desired.

Turning attention now to FIG. 6, here, generally indicated at 44, is a modified system which performs a modified version of the methodology of the. As pictured in FIG. 6, system/methodology 44 is pictured in eight blocks, 46, 48, 50, 52, 54, 56, 58, 60. Block 46 is the equivalent of block 26 in FIG. 2, and block 50 is the equivalent of block 28 in FIG. 2. In associated and cooperative blocks 48, 52, 54, sounds 46 gathered by transducer 16, and sounds 50 gathered by transducer 18, are conventionally reviewed in block 54 to determine whether each appears to contain substantially the same level of noise content. Such a review might typically be performed by comparing these sounds to Gold Standard waveforms, such as those shown at 38a 38b in FIG. 4.

If the “answer” to the “question” posed by block 54 is YES, signal subtraction to suppress noise is performed in block 60 which is the equivalent of previously described block 30 in FIG. 2, and resultant outputting is performed by block 58 which is the equivalent of block 32 in FIG. 2.

If the answer to this question is NO, block 56 selects, for sending to outputting block 58, that particular, transducer-collected sound signal which appears to contain the lower amount of noise. The particular, “acceptable”, lower amount of noise which will be “permitted” so as not to invoke implementation of the “option” here of using or not using noise suppression is entirely a matter of user choice, and those skilled in the relevant art will fully understand how to make such an “acceptance” determination. From, and in, such a selected, but not noise-suppressed, output signal, the S1, S2, S3 and S4 heart sounds are and will be made readable.

From an implementation point of view, the invention may be viewed as offering a method for differentiating two, different-character acoustic signals emanating from a pair of different sources and arriving substantially contemporaneously as combined signals at the sites of a pair of acoustical-to-electrical transducers, where signals arriving at these transducers from one of the sources arrives for both transducers via a common, undifferentiated conveyance medium, and signals arriving from the other source arrive for each transducer via transducer-specific, different conveyance media, and where it is desired to focus attention on a selected and desired category of information conveyed from the other source, with this method including the steps of (a) utilizing such two transducers to acquire common-time-base, combined, two-source acoustical signals, (b) subtracting a selected one of these combined signals from the other combined signal, and by such subtracting, (c) distinguishing and revealing the mentioned selected and desired information acquired from acoustic signals emanating from the other source.

Another view of the invention sees it as providing a method for obtaining and clarifying heart sounds in the presence of noise including (a) establishing a plural-signal receiver, (b) implementing between the human heart and the established plural-signal receiver a pair of different-character, physiological, sound-signal conveyance paths, (c) acquiring from such paths generally common-character, but path-differentiated, different, common-time-base, heart-produced sound signals, (d) performing, for noise “suppression” purposes, a defined sound-signal-from-sound-signal subtraction of a selected one of such acquired sound signals from the other acquired sound signal, and (e) thereafter utilizing the result of such subtraction to produce a human-heart-characteristic interpretable output signal.

Still a further methodologic view of the invention is that it involves (a) declaring low-frequency sounds which arrive at a pair of anatomy-attached sound transducers from the heart to be near-field sounds, (b) declaring all other low-frequency sounds which arrive at the same transducers to be near-field sounds, and (c) employing the arriving far-field sounds in a self-cancellation mode to clarify information content in the arriving near-field sounds.

Thus, plural preferred embodiments of, and manners of practicing, the present invention have been illustrated and described. The invention proposes a very simple and effective system for, and manner of, ridding collected anatomical acoustic data of troublesome far-field noise activity, thus to reveal with good accuracy the mentioned four important S1, S2, S3 and S4 heart sounds.

Other modifications and variations of the invention may become apparent to those skilled in the relevant art, and all such modifications and variations are considered to come with in the scope and spirit of the invention.

I claim:

1. A method for differentiating, where desired, two, different-character acoustic signals emanating from a pair of different sources and arriving substantially contemporaneously as combined signals at the sites of a pair of acoustical-to-electrical transducers, where signals arriving at these transducers from one of the sources arrives for both transducers via a common, undifferentiated conveyance medium, and signals arriving from the other source arrive for each transducer via transducer-specific, different conveyance media, and where it is desired to focus attention on a selected and desired category of information conveyed from the other source, said method comprising
utilizing the two transducers, acquiring common-time-base, combined, two-source acoustical signals,
subtracting a selected one of these combined signals from the other combined signal, and
by said subtracting, distinguishing and revealing the mentioned selected and desired information acquired from acoustic signals emanating from the other source.

2. The method of claim 1, wherein said subtracting step, and said subtracting-based distinguishing and revealing steps, are optional alternatives to a precursor step involving examining the two transducer-acquired, combined acoustical signals to determine if they have significantly differing noise content, and if they do, employing the lower noise-content combined signal as one indicating the selected and desired information.

3. The method of claim 1, wherein the transducers are placed in contact with the skin on the surface of the human anatomy, the one source takes the form of acoustical behavior occurring on the outside of the human anatomy, the common conveyance medium is the skin, the other source is the heart inside the same anatomy, and the different conveyance media each takes the form of a different anatomical acoustic path extending from the heart to one but not the other of the two transducers.

4. The method of claim 3, wherein the selected and desired information includes the S1, S2, S3 and S4 heart sounds.

5. A system for obtaining and clarifying heart sounds in the presence of noise including
a pair of close-proximity sound transducers applied adjacent one another to a pair of nearby sites on the human body for gathering heart and external-source sounds, and for producing from such gathered sounds related, sound-based electrical signals,
structure coupled to the two transducers for receiving, and producing electronic subtraction, one-from-another, of such two produced signals, and
structure operatively connected to the above first-mentioned structure, operable to produce a discernable, interpretable output based upon such electronic subtraction.

6. The system of claim 5 which further includes output option structure operatively connected to the two transducers for the purpose of determining whether sound signals received thereby are substantially similar in noise-level content, and operable, if such similarity does not exist, to select for output those signals coming from the transducer which has received a sound signal with the lower-level noise content.

7. A method for obtaining and clarifying heart sounds in the presence of noise including
(a) establishing a plural-signal receiver,
(b) implementing between the human heart and the established plural-signal receiver a pair of different-character, physiological, sound-signal conveyance paths,
(c) acquiring from such paths generally common-character, but path-differentiated, different, common-time-base, heart-produced sound signals,
(d) performing, for noise “suppression” purposes, a defined sound-signal-from-sound-signal subtraction of a selected one of such acquired sound signals from the other acquired sound signal, and
(e) utilizing the result of such subtraction to produce a human-heart-characteristic interpretable output signal.

8. A method for collecting low-frequency sounds from the surface of the anatomy via acoustic transducers attached to the anatomy comprising p1 declaring such low-frequency sounds which arrive at such transducers from the heart to be near-field sounds,
declaring all other low-frequency sounds which arrive at such transducers to be near-field sounds, and
employing the arriving far-field sounds in a self-cancellation mode to clarify information content in the arriving near-field sounds.
